(19) United States
(12) Patent Application Publication
(10) Pub. No.: US 2024/0225099 A1
(43) Pub. Date: Jul. 11, 2024

(54) AEROSOL GENERATION DEVICE AND SYSTEM

(71) Applicant: SHENZHEN FIRST UNION TECHNOLOGY CO., LTD., Shenzhen City, Guangdong Province (CN)

(72) Inventors: PEIXIA YU, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/558,178

(22) PCT Filed: Apr. 15, 2022
(86) PCT No.: PCT/CN2022/087138

§ 371 Date: Oct. 30, 2023

(30) Foreign Application Priority Data
Apr. 30, 2021 (CN) 202110478272.2

(51) Int. Cl. A24F 40/40; A24F 40/46; H05B 3/22

(52) U.S. Cl. CPC A24F 40/40; H05B 3/22; A24F 40/46

(57) ABSTRACT

An aerosol generation device and system are provided. The aerosol generation device includes: a housing, having an inlet, where the inlet is configured for at least part of an aerosol generation product containing an inhalable material to be removably inserted into the aerosol generation device; a heater, arranged in the housing and configured to heat the inhalable material in the aerosol generation product to generate an aerosol; and a heat transfer element, where at least part of the heat transfer element is arranged between the inlet and the heater. The heat transfer element is configured to come into thermally conductive contact with at least part of a surface of the aerosol generation product and transfer partial heat of the aerosol generation product when the aerosol generation product is inserted into the aerosol generation device. Hence, the partial heat of the aerosol generation product is transferred through the heat transfer element.

### CROSS-REFERENCE TO RELATED APPLICATIONS

This application claims priority to Chinese Patent Application No. 2021104782722, filed with the China National Intellectual Property Administration on Apr. 30, 2021 and entitled “AEROSOL GENERATION DEVICE AND SYSTEM”, which is incorporated herein by reference in its entirety.

### TECHNICAL FIELD

This application relates to the technical field of cigarette devices, and in particular, to an aerosol generation device and system.

### BACKGROUND

During use of smoking articles such as a cigarette or cigar, tobaccos are burnt to generate vapor. An attempt has been made to provide substitutes for these tobacco-burning articles by producing products that release compounds without burning. An example of the products is a heat-not-burn product, which releases compounds by heating tobaccos rather than burning tobaccos.

A document with the Application Publication No. of CN109068748A discloses a device for heating an inhalable material. When the consumable is inserted into a device, an air gap exists between a hollow chamber and the consumable, and cold air can enter the chamber from the outside of the device through a vent path, thereby helping to lower the temperature and reduce the content of the water vapor component released by the heated volatile component from the inhalable material.

The cigarette device has the problem that the cold air outside the device is used to cool the cigarette, the cooling effect is not ideal, and the inhaler may easily have a burning sensation during inhalation. Especially in the first puff, due to the relatively high moisture content in the cigarette, the water vapor with high heat after being heated and evaporated makes the inhaler feel more obvious.

### SUMMARY

This application provides an aerosol generation device and system, so as to solve the problem that the existing cigarette device is easy to cause an inhaler to have a burning sensation during inhalation.

An aspect of this application provides an aerosol generation device, including:
a housing, having an inlet, where the inlet is configured for at least part of an aerosol generation product containing an inhalable material to be removably inserted into the aerosol generation device;
a heater, arranged in the housing and configured to heat the inhalable material in the aerosol generation product to generate an aerosol; and
a heat transfer element, where at least part of the heat transfer element is arranged between the inlet and the heater; and
the heat transfer element is configured to come into thermally conductive contact with at least part of a surface of the aerosol generation product and transfer partial heat of the aerosol generation product when the aerosol generation product is inserted into the aerosol generation device.

Another aspect of this application provides an aerosol generation system, including an aerosol generation product and an aerosol generation device.

Through the aerosol generation device provided in this application, partial heat of the aerosol generation product is removed through the heat transfer element, which avoids a problem that an inhaler is prone to burning pain during inhalation or a first puff, thereby improving inhalation experience of users.

### BRIEF DESCRIPTION OF THE DRAWINGS

One or more embodiments are exemplarily described with reference to the corresponding figures in the accompanying drawings, and the descriptions are not to be construed as a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of an aerosol generation device according to an implementation of this application;

FIG. 2 is a schematic cross-sectional view of an aerosol generation device according to an implementation of this application;

FIG. 3 is a schematic cross-sectional view of an aerosol generation system according to an implementation of this application;

FIG. 4 is a schematic exploded view of an aerosol generation device according to an implementation of this application;

FIG. 5 is a schematic diagram of FIG. 4 from another perspective; and

FIG. 6 is a schematic diagram of a heater according to an implementation of this application.

### DETAILED DESCRIPTION

For ease of understanding of this application, this application is described below in more detail with reference to the accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. A term “and/or” used in this specification includes any or all combinations of one or more related listed items.

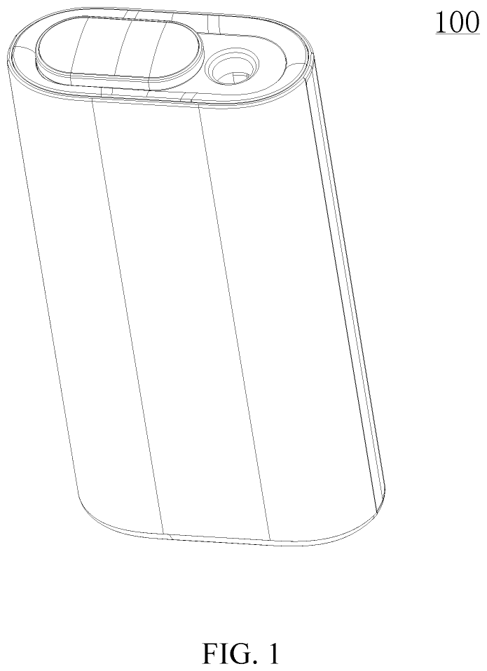

Referring to FIG. 1 to FIG. 6, implementations of this application provide an aerosol generation device 100, including:

a housing 13, which may be composed of a plurality of parts, for example: an upper cover, a body, and a lower cover (not shown in the figure). The housing 13 is internally provided with an accommodating space that may accommodate a heater 131, a core 132, a circuit 133, and the like.

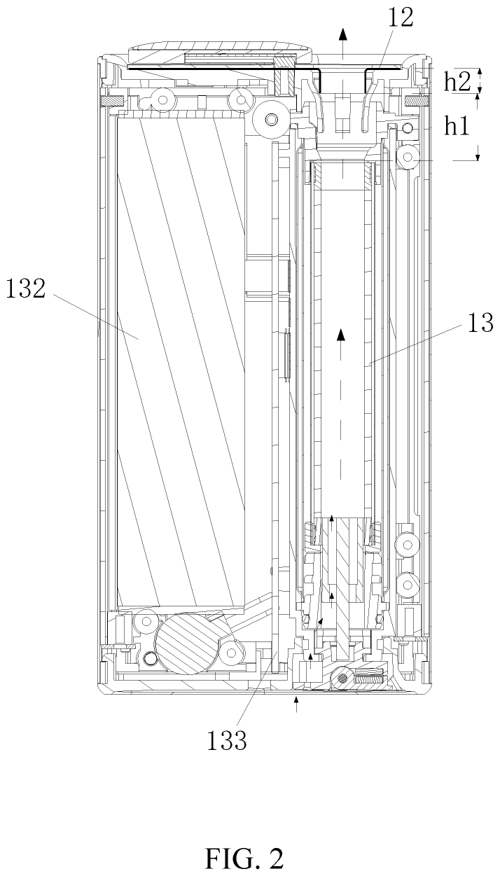

The housing 13 has a first end and a second end opposite to each other, the first end is provided with an inlet 13a, and the second end is provided with a cleaning port 13b. At least part of the aerosol generation product 20 is removably inserted into the aerosol generation device 100 through the inlet 13a. The first end is provided with a heat transfer element 12 and a cover assembly 11 in sequence. The cover assembly 11 has a sliding cover capable of sliding left and right relative to the housing 13 and a through hole corresponding to the inlet 13a, and the inlet 13a can be opened or covered by the movement of the sliding cover. A cleaning plug 14 is arranged on the second end, and the cleaning plug 14 is detachably inserted into the aerosol generation device 100 through the cleaning port 13b. When the aerosol generation product 20 is inserted into the aerosol generation device 100, the cleaning plug 14 can provide an end stop to hold a heating section 23 of the aerosol generation product 20 in a heating region. The cleaning plug 14 is further provided with an air inlet channel, external cold air flows in through the air inlet channel, passes through the heater 131, and then flows out from the inlet 13a. Specifically, reference may be made to the arrows shown in FIG. 2.

The heater 131 is configured to heat the inhalable material in the aerosol generation product 20 to generate an inhalable aerosol.

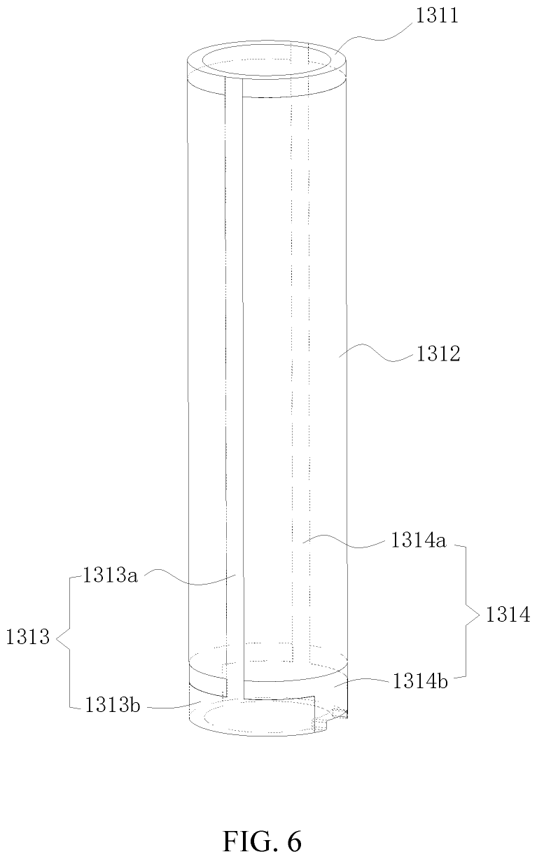

FIG. 6 shows a heater 131 according to an implementation of this application. The heater 131 includes:
a base body 1311, constructed in the shape of a tube extending in an axial direction of the chamber 11 and surrounding the chamber 11. Specifically, the base body 1311 includes a first end, a second end, and a surface extending between the first end and the second end. The base body 1311 may be in the shape of a cylinder, a prism, or another column. The base body 1311 is preferably in the shape of a cylinder, and a cylindrical hole extending through a middle part of the base body 1311 forms a heating chamber. An inner diameter of the hole is slightly greater than an outer diameter of an aerosol generation product 20, so that the aerosol generation product 20 can be easily placed in the heating chamber for heating. The heating chamber is substantially in linear communication with the inlet 13a and the cleaning port 13b. The base body 1311 may be made of a material that is high temperature-resistant and transparent, such as quartz glass, ceramic, or mica, or may be made of a material having a high infrared transmittance, for example: a high temperature-resistant material having an infrared transmittance higher than 95%, which is not specifically limited herein.

An infrared electrothermal coating 1312 is formed on a surface of the base body 1311. The infrared electrothermal coating 1312 may be formed on an outer surface of the base body 1311, or may be formed on an inner surface of the base body 1311. The infrared electrothermal coating 1312 receives electric power to generate heat, and then generates infrared rays of a specific wavelength, for example, far infrared rays in a range of 8 μm to 15 μm. When a wavelength of the infrared ray matches an absorption wavelength of the inhalable material, energy of the infrared ray is easily absorbed by the inhalable material. The wavelength of the infrared ray is not limited, and the infrared rays may be infrared rays in a range of 0.75 μm to 1000 μm, preferably far infrared rays in a range of 1.5 μm to 400 μm.

A conductive element includes a first electrode 1313 and a second electrode 1314 arranged on the base body 1311 and spaced apart from each other, which are configured to feed the electric power to the infrared electrothermal coating 1312. Both the first electrode 1313 and the second electrode 1314 are at least partially electrically connected to the infrared electrothermal coating 1312, so that a current can flow from one electrode to the other electrode through the infrared electrothermal coating 1312.

The first electrode 1313 and the second electrode 1314 are symmetrically arranged along a central shaft of the base body 1311. The first electrode 1313 includes a coupled electrode 1313b extending in a circumferential direction of the base body 1311 and a strip-shaped electrode 1313a extending in an axial direction from the coupled electrode 1313b towards the first end of the base body 1311. The coupled electrode 1313b is not in contact with the infrared electrothermal coating 1312, and the strip-shaped electrode 1313a is at least partially in contact with the infrared electrothermal coating 1312 to form an electrical connection. The second electrode 1314 includes a coupled electrode 1314b extending in a circumferential direction of the base body 1311 and a strip-shaped electrode 1314a extending in an axial direction from the coupled electrode 1314b towards the first end of the base body 1311. The coupled electrode 1314b is not in contact with the infrared electrothermal coating 1312, and the strip-shaped electrode 1314a is at least partially in contact with the infrared electrothermal coating 1312 to form an electrical connection.

In this example, both the first electrode 1313 and the second electrode 1314 are conductive coatings, the conductive coating may be a metal coating, a conductive tape, or the like, and the metal coating may be made of silver, gold, palladium, platinum, copper, nickel, molybdenum, tungsten, niobium, or an alloy material of the foregoing metal.

Further, referring to FIG. 2, the aerosol generation device 100 further includes a heat insulation tube sleeved outside the base body 1311. The heat insulation tube has an inner tube and an outer tube in a radial direction, a sealed space is formed between the inner tube and the outer tube, and the sealed space may be vacuumized, or may be filled with gas, a heat insulation material, or the like. The gas includes, but is not limited to, an inert gas, air, carbon dioxide, or the like, and the heat insulation material includes, but is not limited to, a material with a low thermal conductivity, such as an aerogel, a mica sheet, a mica tube, alumina oxide matrix porous ceramic, cordierite, a rock wool board, or a rock wool felt.

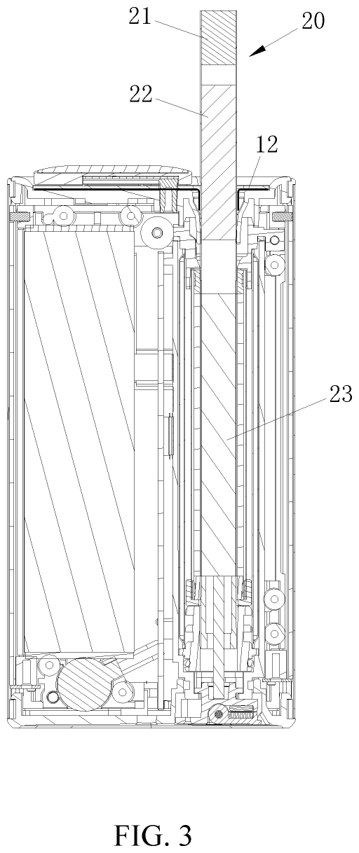

It should be noted that, an infrared transmitter formed by the infrared electrothermal coating 1312, the first electrode 1313, and the second electrode 1314 is not limited to the example in FIG. 3. In another example, the infrared transmitter may be formed by a thermally excited infrared radiation layer, may be constructed by a thin film wound on the base body 1311, or the like.

It should be further noted that, in the foregoing example, the heater 131 is described in an infrared heating manner. In another example, the heating manner of the heater 131 may be resistance heating, electromagnetic heating, or the like, which is not limited thereto. The number of heaters 131 is not limited herein, and may be one or more.

In this example, the heat transfer element 12 includes a tubular shell and a capillary liquid absorbing core located in the tubular shell. After the tubular shell is filled with an appropriate amount of working liquid after being pumped to a specific negative pressure, so that the capillary porous material of the liquid absorbing core tightly attached to an inner wall of the tubular shell is filled with liquid, and then the tubular shell is sealed. In this way, when one end of the heat transfer element 12 is heated, the working liquid in the tubular shell quickly vaporizes, vapor flows to another end under the power of thermal diffusion, and condenses at the cold end to release heat, and then the working liquid flows back to an evaporation end by capillary action along the capillary liquid absorbing core. Such a cycle is repeated until the temperatures at two ends of the heat transfer element 12 are equal.

The tubular shell may be made of materials with a high thermal conductivity, for example: copper, aluminum, carbon steel, stainless steel, and alloy steel. The working liquid is selected from materials with a relatively high specific heat capacity, for example: water, liquid ammonia, liquid hydrogen, and acetic acid. Preferably, the working liquid is water.

referring to FIG. 2 and FIG. 4 to FIG. 5, in this example, the heat transfer element 12 includes an insertion portion 121 and an extension 122.

The insertion portion 121 is arranged between the inlet 13a and the heater 131, and has a proximal end 121a and a distal end 121b opposite to each other. The proximal end 121a is arranged close to the inlet 13a or flush with the inlet 13a, and the distal end 121b extends into the aerosol generation device 100 through the inlet 13a, that is, extends towards the heater 131.

In this example, the insertion portion 121 is constructed in the shape of a tube surrounding the part of the aerosol generation product 20, and the aerosol generation product 20 can pass through a cavity of the insertion portion 121 and then be at least partially inserted into the heater 131. As an optional implementation, an inner surface of the insertion portion 121 is provided with one or more bumps (not shown in the accompanying drawing) arranged at intervals in a circumferential direction. In this way, when the aerosol generation product 20 is inserted into the aerosol generation device 100, the bump keeps in contact with the aerosol generation product 20.

In another example, it is also feasible that the shape of the insertion portion 121 constructed to partially surround the aerosol generation product 20, for example, semi-tubular (a cross section is arc-shaped). The insertion portion 121 may further be constructed in the shape of a sheet and a strip and another regular or irregular shape, or the like in thermally conductive contact with at least part of a surface of the aerosol generation product 20. As an optional implementation, one or more insertion portions 121 may be arranged.

The extension 122 extends from the proximal end 121a in the radial direction of the insertion portion 121, and the shape of the extension substantially matches a shape of an upper end of the housing 13. The extension 122 is held on the housing 13, and may be fixed to the housing 13 through an adhesive material or fixed to the housing 13 through a fixed connector, which is not limited herein.

With reference to FIG. 3 for understanding, the aerosol generation product 20 and the aerosol generation device 100 constitute an aerosol generation system. The aerosol generation product 20 includes a filter section 21, a heating section 23 containing an inhalable material, and a connecting section 22 arranged between the filter section 21 and the heating section 23.

The inhalable material is a substrate that can release volatile compounds forming aerosols. The volatile compound may be released by heating the inhalable material. The inhalable material may be solid, liquid, or components including solid and liquid. The inhalable material may be loaded onto a carrier or a supporting member through adsorbing, coating, impregnating, or in other manners.

When the aerosol generation product 20 is inserted into the aerosol generation device 100, the heating section 23 is located in the heating chamber of the base body 1311, and the heat transfer element 12 is in thermally conductive contact with the connecting section 22. In this way, during inhalation, partial heat of the connecting section 22 may be absorbed and transferred through the phase change of the working liquid in the heat transfer element 12, thereby reducing the temperature at the connecting section 22 or the filter section 21, which avoids a problem that an inhaler is prone to burning pain during inhalation or a first puff, thereby improving inhalation experience of users.

It should be noted that, it is also feasible that the heat transfer element 12 may be in thermally conductive contact (direct contact or indirect contact) with the filter section 21 and the connecting section 22. One or more connecting sections 22 may be arranged in the aerosol generation product 20. In another example, the aerosol generation product 20 may not have the connecting section 22. That is to say, the aerosol generation product 20 includes only a filter section 21 and a heating section 23 containing an inhalable material. In this case, when the aerosol generation product 20 is inserted into the aerosol generation device 100, the heating section 23 is located in the heating chamber of the base body 1311, and the heat transfer element 12 may be in thermally conductive contact with a part of the filter section 21. As an optional implementation, when the aerosol generation product 20 is inserted into the heating chamber, the heat transfer element 12 surrounds a part of an outer surface of the filter section 21. The part may be a part of a surface region away from an end of the filter section 21, so as to transfer partial heat downstream of the aerosol generation product 20, thereby reducing the temperature of the filter section 21, especially the end of the filter section 21 contacting a lip.

Referring to FIG. 2 again, in order to avoid transferring heat of the heater 131 by the heat transfer element 12, on the one hand, the heat transfer element 12 is kept not in contact with the heater 131, and on the other hand, a distance h1 between the distal end 121b of the insertion portion 121 and the heater 131 is greater than a distance h2 between the distal end 121b and the inlet 13a. Preferably, h1≥2*h2.

It should be noted that, in another example, it is also feasible that the heat transfer element 12 does not include a capillary liquid absorbing core. In this case, the working liquid may flow back to the evaporation end by gravity or another acting force.

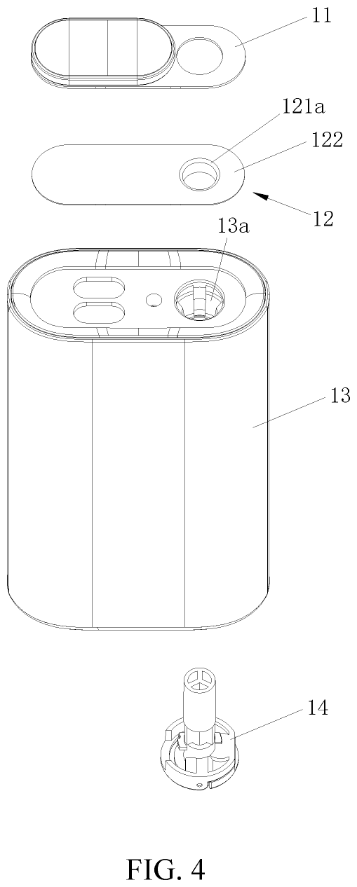

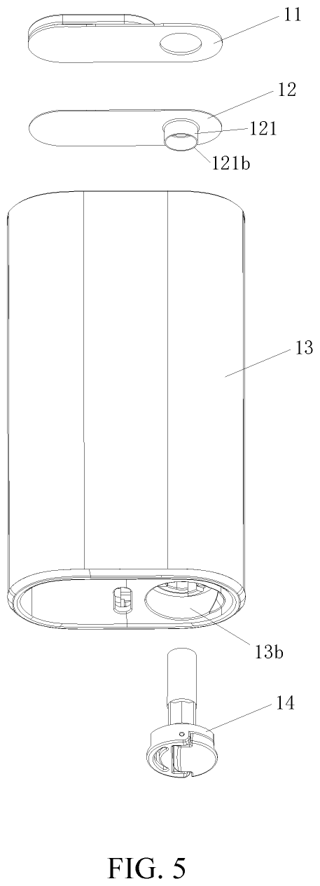

It should be further noted that, in another example, it is also feasible that the heat transfer element 12 does not include high specific heat capacity materials. For the specific structure thereof, reference may be made to FIG. 4 to FIG. 5 and the foregoing contents. In this case, the heat transfer element 12 does not need to be filled with the working liquid inside, and a solid structure may be adopted. Alternatively, in another example, it is also feasible that a part of the heat transfer element 12 includes a high thermal conductivity material, and another part thereof includes a high specific heat capacity material.

It should be further noted that, in the above examples, the working liquid is used for description. That is to say, partial heat of the aerosol generation product 20 is transferred through transition from a liquid phase to a gas phase of the working liquid. It can be easily imagined that in another example, it is feasible that another phase change material may be adopted. For example: a paraffin material is used to transfer partial heat of the aerosol generation product 20 through transition from a solid phase to a liquid phase of paraffin.

A core 132 provides electric power for operating the aerosol generation device 100. For example, the core 132 may provide electric power to heat the heater 131. In addition, the core 132 may provide the electric power required for operating other components provided in the aerosol generation device 100.

The core 132 may be a rechargeable battery or a disposable battery. The core 132 may be, but is not limited to, a lithium iron phosphate (LiFePO₄) battery. For example, the core 132 may be a lithium cobaltate (LiCoO₂) battery or a lithium titanate battery.

A circuit 133 may control overall operations of the aerosol generation device 100. The circuit 133 not only controls operations of the core 132 and the heater 131, but also controls operations of other components in the aerosol generation device 100. For example: the circuit 133 obtains temperature information of the heater 131 that is sensed by a temperature sensor, and controls, based on the information, the electric power supplied to the heater 131 by the core 132.

It should be noted that, the specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing descriptions, and all the improvements and modifications shall fall within the protection scope of the appended claims of this application.

1. An aerosol generation device, comprising:
a housing, having an inlet, wherein the inlet is configured for at least part of an aerosol generation product containing an inhalable material to be removably inserted into the aerosol generation device;
a heater, arranged in the housing and configured to heat the inhalable material in the aerosol generation product to generate an aerosol; and
a heat transfer element, wherein at least part of the heat transfer element is arranged between the inlet and the heater; and
at least part of the heat transfer element is configured to come into thermally conductive contact with at least part of a surface of the aerosol generation product and transfer partial heat of the aerosol generation product when the aerosol generation product is inserted into the aerosol generation device.

2. The aerosol generation device according to claim 1, wherein the heat transfer element comprises an insertion portion, and the insertion portion has a proximal end and a distal end opposite to each other; and
the proximal end is arranged close to the inlet, and the distal end extends toward the heater.

3. The aerosol generation device according to claim 2, wherein the insertion portion is constructed in the shape of a tube surrounding the part of the surface of the aerosol generation product.

4. The aerosol generation device according to claim 3, wherein an inner surface of the insertion portion is provided with a bump; and
the bump is configured to keep in contact with the aerosol generation product when the aerosol generation product is inserted into the aerosol generation device.

5. The aerosol generation device according to claim 4, wherein a plurality of bumps are arranged, and the plurality of bumps are arranged at intervals in a circumferential direction along the inner surface of the insertion portion.

6. The aerosol generation device according to claim 2, wherein the distal end of the insertion portion is kept not in contact with the heater.

7. The aerosol generation device according to claim 6, wherein a distance between the distal end and the heater is greater than a distance between the distal end and the inlet.

8. The aerosol generation device according to claim 7, wherein the distance between the distal end and the heater is more than twice the distance between the distal end and the inlet.

9. The aerosol generation device according to claim 2, wherein the heat transfer element further comprises an extension held on the housing.

10. The aerosol generation device according to claim 9, wherein the extension extends radially from the proximal end of the insertion portion.

11. The aerosol generation device according to claim 1, wherein a material of the heat transfer element is selected from at least one of copper, aluminum, carbon steel, stainless steel, and alloy steel.

12. The aerosol generation device according to claim 1, wherein the heat transfer element further comprises a phase change material to transfer the partial heat of the aerosol generation product through a phase change of the phase change material.

13. The aerosol generation device according to claim 12, wherein the heat transfer element further comprises a tubular shell, and the phase change material is sealed in the tubular shell.

14. The aerosol generation device according to claim 12, wherein the phase change material comprises at least one of water, liquid ammonia, liquid hydrogen, acetic acid, and paraffin.

15. An aerosol generation system, comprising the aerosol generation product and the aerosol generation device according to claim 1.

16. The aerosol generation system according to claim 15, wherein the aerosol generation product comprises a filter section and a heating section containing an inhalable material; and
at least part of the heat transfer element is in thermally conductive contact with a surface of the filter section.

17. The aerosol generation system according to claim 15, wherein the aerosol generation product comprises a filter section, a heating section containing an inhalable material, and a connecting section arranged between the filter section and the heating section; and
the heat transfer element is in thermally conductive contact with a surface of the connecting section, or the heat transfer element is in thermally conductive contact with both a surface of the filter section and the surface of the connecting section.
